(19) United States
(12) Patent Application Publication
(10) Pub. No.: US 2010/0034130 A1
(43) Pub. Date: Feb. 11, 2010

(54) Dynamic Discovery of Multicast Broadcast Services controller and Synchronization in Wireless Communication Systems

(76) Inventors: Tricci So, San Diego, CA (US); Yang Wei Tu, Nanjing (CN); Li Chu, Shenzhen (CN)

Correspondence Address: FISH & RICHARDSON, PC, P.O. BOX 1022, MINNEAPOLIS, MN, 55440-1022, US

(21) Appl. No.: 12/534,782

(22) Filed: Aug. 3, 2009

Related U.S. Application Data
(60) Provisional application No. 61/085,786, filed on Aug. 1, 2008.
(60) Provisional application No. 61/089,837, filed on Aug. 18, 2008.
(60) Provisional application No. 61/092,675, filed on Aug. 28, 2008.

(51) Int. Cl. H04H 20/71; H04L 27/28

(52) U.S. Cl. 370/312; 375/260

(57) ABSTRACT

Systems, apparatuses, and techniques for wireless communications can include operating an access service network to provide wireless communications to wireless devices based on an orthogonal frequency-division multiplexing air interface and can include receiving a service profile associated with a wireless device from a connectivity service network which is configured to determine whether the wireless device has privilege to access a multicast broadcast controller. A service profile can include access information to facilitate communications between the wireless device and the multicast broadcast controller. Systems, apparatuses, and techniques can include storing the access information in a network node configured to transact messages based on a Dynamic Host Configuration Protocol (DHCP) with wireless devices and can include operating the network node, based on the access information in response to a DHCP message sent by the wireless device, to provide address information to enable the wireless device to communicate with the multicast broadcast controller.

### CROSS REFERENCE TO RELATED APPLICATIONS

This document claims the benefit of the priority of U.S. Provisional Application Ser. No. 61/085,786, filed Aug. 1, 2008 and entitled “Dynamic Discovery of Multicast Broadcast Services Controller and Synchronization in Wireless Communication Systems.” This document additionally claims the benefit of the priority of U.S. Provisional Application Ser. No. 61/089,837, filed Aug. 18, 2008 and entitled “MBS Synchronous Transmission Support Over WiMAX Access Network.” This document additionally claims the benefit of the priority of U.S. Provisional Application Ser. No. 61/092,675, filed Aug. 28, 2008 and entitled “MBS Synchronous Transmission Support Over WiMAX Access Network.” The entire contents of all of the above identified documents are hereby incorporated by reference.

### BACKGROUND

This document relates to wireless communication systems.

Wireless communication systems use electromagnetic waves to communicate with fixed and mobile wireless communication devices such as mobile wireless phones and laptop computers with wireless communication cards. Wireless communication systems can include a network of base stations to communicate with wireless devices registered for services in the systems. For example, such systems can include a network of one or more base stations to communicate with one or more wireless devices such as a mobile device, cell phone, wireless air card, a wireless station, user equipment (UE), access terminal (AT), or subscriber station (SS). A wireless device can be referred to as a mobile station (MS) or a mobile node (MN).

A base station (BS) can emit radio signals that carry data such as voice data and other data content to wireless devices. Such a signal from a base station can include information for various communication management functions, including information to allow a wireless device to identify a cell sector of a base station, to synchronize signaling in time and frequency. A wireless device can processes such information prior to processing of payload data.

A base station and a wireless device can wirelessly communicate using one or more wireless air interface technologies such as orthogonal frequency division multiplexing (OFDM) and orthogonal frequency division multiple access (OFDMA). Some wireless communication systems can operate in accordance with an IEEE 802.16 specification, such as IEEE 802.16e-2005. Some wireless communication systems can operate in accordance with 3GPP2 and 3GPP specifications. Various examples of air interface technologies include wireless interoperability for microwave access (WiMAX), Code Division Multiple Access (CDMA), CDMA2000, High Rate Packet Data (HRPD), and Universal Mobile Telecommunications System (UMTS) technologies.

### SUMMARY

This document describes technologies for wireless communication techniques, apparatuses, and systems.

In one aspect, techniques for wireless communication can include operating an access service network to provide wireless communications to wireless devices based on an orthogonal frequency-division multiplexing air interface and can include receiving a service profile associated with a wireless device from a connectivity service network which is configured to determine whether the wireless device has privilege to access a multicast broadcast controller. A service profile can include access information to facilitate communications between the wireless device and the multicast broadcast controller. Techniques can include storing the access information in a network node configured to transact messages based on a Dynamic Host Configuration Protocol (DHCP) with wireless devices and can include operating the network node, based on the access information in response to a DHCP message sent by the wireless device, to provide address information to enable the wireless device to communicate with the multicast broadcast controller. Other implementations can include corresponding systems, apparatus, and computer programs, configured to perform the actions of the techniques, encoded on computer readable mediums.

These and other implementations can include one or more of the following features. In some implementations, operating the network node can include transacting DHCP messages with the wireless device, wherein the DHCP includes a DHCP for Internet Protocol (IP) version 6 (IPv6). In some implementations, operating the network node can include transacting DHCP messages with the wireless device, wherein the DHCP includes a DHCP for IP version 4 (IPv4). Operating the network node can include sending an IP address associated with the multicast broadcast controller to the wireless device. Access information can include one or more IP addresses.

In another aspect, operating the network node can include sending a fully qualified domain name (FQDN) associated with the multicast broadcast controller to the wireless device. Access information can include one or more FQDNs. These and other implementations can include causing the wireless device to perform a Domain Name System (DNS) lookup on the FQDN to obtain an IP address associated with the multicast broadcast controller.

In some implementations, access information can include an IP address associated with a DHCP server which stores information pertaining to the multicast broadcast controller. Operating the network node can include communicating with the DHCP server to obtain an IP address associated with the multicast broadcast controller. Address information can include the IP address associated with the multicast broadcast controller.

In yet another aspect, operating the network node can include communicating with the DHCP server to obtain a FQDN associated with the multicast broadcast controller. Address information can include the FQDN associated with the multicast broadcast controller. These and other implementations can include causing the wireless device to perform a Domain Name System (DNS) lookup on the FQDN to obtain an IP address associated with the multicast broadcast controller.

Apparatuses and systems for wireless communication can include means for providing wireless communications to wireless devices based on an orthogonal frequency-division multiplexing air interface. Apparatuses and systems can include means for receiving a service profile associated with a wireless device from a connectivity service network which is configured to determine whether the wireless device has privilege to access a multicast broadcast controller. A service profile can include access information to facilitate communications between the wireless device and the multicast broadcast controller. Apparatuses and systems can include a transaction mechanism that transacts messages based on a DHCP with wireless devices. Apparatuses and systems can include can include means for storing the access information in the transaction mechanism to operate the transaction mechanism, based on the access information in response to a DHCP message sent by the wireless device, to provide address information to enable the wireless device to communicate with the multicast broadcast controller.

In another aspect, apparatuses and systems for wireless communication can include a multicast broadcast controller configured to control multicast and broadcast services; a connectivity service network which is configured to determine whether wireless devices have a privilege to access the multicast broadcast controller; and an access service network, in communication with the connectivity service network and the multicast broadcast controller. An access service network can include a base station configured to provide wireless communications to wireless devices based on an orthogonal frequency-division multiplexing air interface. An access service network can include a network node configured to transact messages based on a Dynamic Host Configuration Protocol (DHCP) with wireless devices. An access service network can include a mechanism configured to receive a service profile associated with a wireless device from the connectivity service network and to store access information associated with the service profile in the network node. A service profile can include access information to facilitate communications between the wireless device and the multicast broadcast controller. A network node can be configured to provide, based on the access information in response to a DHCP message sent by the wireless device, address information to enable the wireless device to communicate with the multicast broadcast controller.

These and other implementations can include one or more of the following features. A network node can be configured to send an IP address associated with the multicast broadcast controller to the wireless device and access information can include the IP address. A network node can be configured to send a FQDN associated with the multicast broadcast controller to the wireless device, where the access information can include the FQDN.

In some implementations, access information can include an IP address associated with a DHCP server which stores information pertaining to the multicast broadcast controller. A network node can be configured to communicate with the DHCP server to obtain an IP address associated with the multicast broadcast controller, where the address information can include the IP address associated with the multicast broadcast controller. A network node can be configured to communicate with the DHCP server to obtain a FQDN associated with the multicast broadcast controller, where the address information can include the FQDN. A network node can be configured to transact DHCP messages with the wireless device, where the DHCP includes a DHCP for IPv6. A network node can be configured to transact DHCP messages with the wireless device, where the DHCP includes a DHCP for IPv4.

A wireless device can include transceiver electronics to communicate with one or more access service networks based on an orthogonal frequency-division multiplexing air interface; and processor electronics, in communication with the transceiver electronics, configured to discover address information associated with a multicast broadcast controller. A wireless device can include a memory configured with pre-provisioned address information of a multicast broadcast controller; and a mechanism to select between discovering address information of a multicast broadcast controller or using the pre-provisioned address information.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 shows an example of a wireless communication system.

FIG. 2 shows an example of a radio station architecture.

FIG. 3 shows an example of an access service network sharing architecture.

FIG. 4 shows an example of a connectivity diagram between a wireless device and a multicast broadcast service controller.

FIG. 5 shows an example of a dynamic discovery process in an access service network.

FIG. 6A shows an example of a dynamic discovery process in a wireless device.

FIG. 6B shows a different example of a dynamic discovery process in a wireless device.

FIGS. 7, 8, 9, 10, 11, 12, 13, and 14 show various examples of communications flows associated with different dynamic discovery techniques.

Like reference symbols in the various drawings indicate like elements.

### DETAILED DESCRIPTION

Wireless technology is capable of providing broadband high capacity for various data services, such as voice and data services, and multimedia services (e.g., IPTV or Mobile TV services) over wireless broadband access networks. Multicast Broadcast Services (MCBCS) via a wireless communication system is a service that is being standardized in various mobile wireless standard bodies such as Third Generation Partnership Project 2 (3GPP2), Open Mobile Alliance (OMA), 3GPP Long Term Evolution (LTE), and Worldwide Interoperability for Microwave Access (WiMAX). A MCBCS can provide rich multimedia content to wireless devices in a wireless communication system.

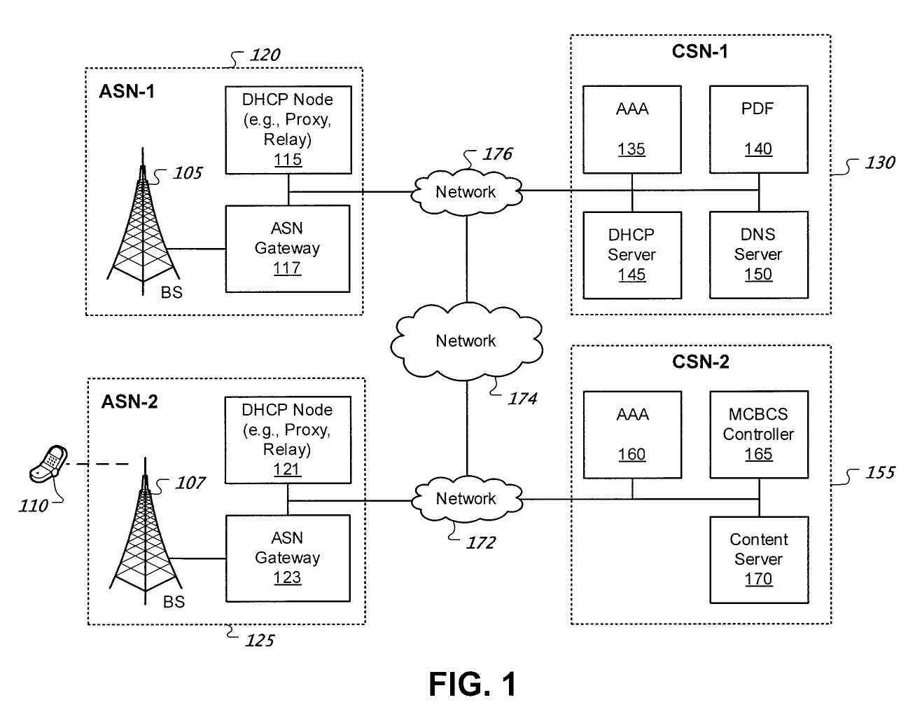

FIG. 1 shows an example of a wireless communication system. The techniques described herein can be implemented in a system such as the one shown in FIG. 1. A wireless communication system can include one or more Access Service Networks (ASNs) 120, 125 and can include one or more Connectivity Service Networks (CSNs) 130, 155. An ASN 120, 125 can include one or more base stations (BSs) 105, 107 to provide wireless services to wireless devices. Some wireless communication systems can refer to a base station as an access point. A base station 105, 107 can transmit a signal on a forward link (FL), called a downlink (DL) signal, to one or more wireless devices 110. A wireless device 110 can transmit a signal on a reverse link (RL), called an uplink (UL) signal, to one or more base stations 105, 107.

A wireless communication system can include one or more Broadcast Multicast Services (MCBCS) to provide broadcast and multicast services to wireless devices. A MCBCS can include a controlling functional component responsible for controlling and managing the service via interacting with wireless devices and network entities including a radio access network. A wireless communication system can include one or more MCBCS controllers 165 and one or more content servers 170 configured to provide content such as multicast content and broadcast content to wireless devices. Some systems can include an integrated MCBCS controller 165 and content server 170. In some implementations, different functional aspects of either a MCBCS controller 165 or a content server 170 can reside on one or more different servers. Some system implementations can include one centralized addressable entity responsible for providing and controlling MCBCS to entities such as an ASN or a wireless device.

In some implementations, a MCBCS controller 165 can perform IP multicast group management, MCBCS program management, MCBCS service announcement management such as MCBCS programming guide manipulation and distribution, MCBCS session management, and delivery of the mapping information such as a mapping between a MCBCS content IP address and a Multicast Connection ID (MCID). A MCBCS controller 165 can provide security functions such as MCBCS data encryption support, application layer key management, and security association support for the application layer.

An ASN 120, 125 can include one or more ASN Gateways (ASN-GWs) 117, 123. In some implementations, an ASN 120, 125 can communicate with a corresponding CSN 130, 155 via one or more networks 172, 174, 176 such as an Internet Protocol (IP) based network. A CSN 130, 155 can include one or more of MCBCS controller 165, content server 170, Authentication, Authorization, Accounting (AAA) server 135, 160, Policy Decision Function (PDF) 140. A CSN 130, 155 can include a Domain Name System (DNS) server to translate between domain names and IP addresses.

In some implementations, a CSN 130, 155 can include a subscriber profile repository configured to store and manage subscriber profiles. Entities such as an AAA server 135, 160 or a PDF 140 can control a wireless device's access to network services and can have access to a subscriber profile repository to obtain a subscriber's service policy information associated with a wireless device. In some implementations, a wireless operator can charge for MCBCS and can control access to MCBCS. In some implementations, an AAA server 135, 160 can perform MCBCS authentication, authorization and accounting.

A wireless communication system can use one or more Dynamic Host Configuration Protocol (DHCP) techniques to provide configuration information to a wireless device. DHCP techniques can be used to configure various IP address and other types of parameters. In some implementations, a DHCP technique can assign an IP address to a wireless device such that the wireless device can send and receive IP data packets. In some implementations, a DHCP technique can provide system information to a wireless device. System information can include address information for one or more servers.

In some implementations, address information provided by a DHCP entity can include an IP address such as an IP version 4 (IPv4) address or an IP version 6 (IPv6) address. In some implementations, address information can include a fully qualified domain name (FQDN). A DHCP servers such as a DHCPv4 server or a DHCPv6 server can provide address information in IPv4 or IPv6 networking environments respectively. Various DHCP entities can function based one or more Internet Engineering Task Force (IETF) documents such as RFC 2131, RFC 3315, or RFC 4280.

In some implementations, a wireless device can communicate with a DNS server 150 to resolve a FDQN into an IP address that a wireless device can use to communicate with a processing device associated with the FDQN.

In some implementations, an ASN 120, 125 can include a mechanism such as an ASN-GW 117, 123 that is configured to perform a wireless device's network entry procedure and to communicate with a CSN 130 to receive a service profile associated with the wireless device from the CSN 130. A service profile can include access information such as a domain name or an IP address of a DHCP server or a MCBCS controller. Access information can facilitate communications between a wireless device and a multicast broadcast controller. The ASN-GW 117, 123 can store the access information in a network node such as a DHCP node 115, 121. An ASN-GW 117, 123 can include one or more processing devices to perform functions described herein, the one or more devices can be located in one or more physical locations.

A wireless device 110 can have a home ASN and a home CSN such as ASN-1 120 and CSN-1 130 respectively. The wireless device 110 can move to a geographical area served by a different ASN and CSN, which are known by the context of the wireless device 110 as a visiting ASN (V-ASN) and a visiting CSN (V-CSN) such as ASN-2 120 and CSN-2 115 respectively.

To facilitate communications with a DHCP server, an ASN 120, 125 can include a DHCP node 115, 121 such as a DHCP proxy or a DHCP relay. In some implementations, a DHCP proxy in a ASN can act as a DHCP server for a wireless device that is visiting the ASN. In some implementations, a DHCP relay of an ASN can provide connectivity between a visiting wireless device and a home DHCP server. For example, a DHCP relay can send and receives DHCP messages with a home DHCP server to provide information to a visiting wireless device.

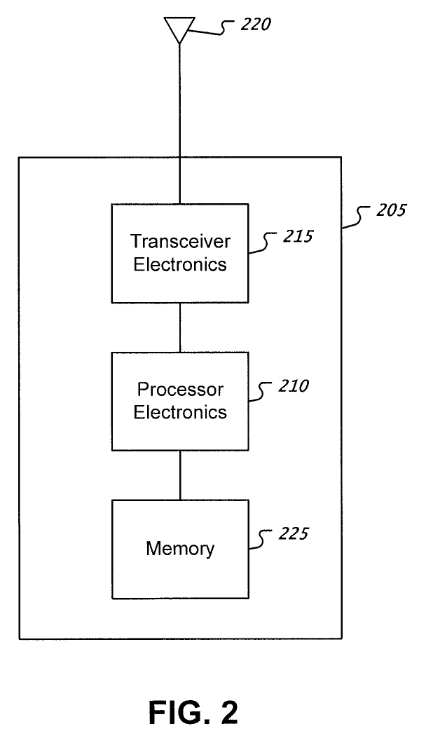

FIG. 2 shows an example of a radio station architecture. Various examples of radio stations include base stations and wireless devices. A radio station 205 such as a base station or a wireless device can include processor electronics 210 such as a microprocessor that implements methods such as one or more of the techniques presented in this document. A radio station 205 can include transceiver electronics 215 to send and/or receive wireless signals over one or more communication interfaces such as one or more antennas 220. A radio station 205 can include other communication interfaces for transmitting and receiving data. In some implementations, a radio station 205 can include one or more wired communication interfaces to communicate with a wired network. A radio station 205 can include one or more memories 225 configured to store information such as data and/or instructions. In some implementations, processor electronics 210 can include at least a portion of transceiver electronics 215 and a memory 225.

Radio stations 205 can communicate with each other based on an orthogonal frequency-division multiplexing (OFDM) air interface which can include Orthogonal Frequency-Division Multiple Access (OFDMA) air interface. In some implementations, radio stations 205 can communicate using one or more wireless technologies such as Worldwide Interoperability for Microwave Access (WiMAX), Long-Term Evolution (LTE), Code division Multiple Access (CDMA) such as CDMA2000 1x, High Rate Packet Data (HRPD), and Universal Mobile Telecommunications System (UMTS).

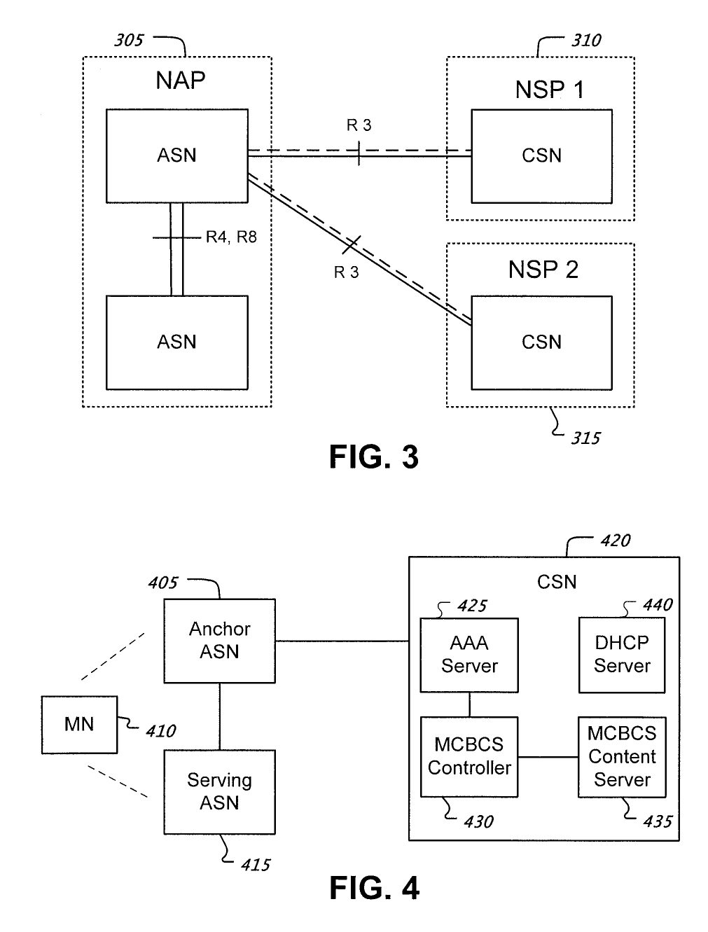

FIG. 3 shows an example of an ASN sharing architecture. Various wireless broadband access business models can include a Network Access Provider (NAP) and a Network Service Provider (NSP). A NAP 305 is a type of wireless operator that is responsible for managing and controlling one or more ASNs. A NSP 310, 315 is a different type of wireless operator that is responsible for managing and controlling one or more CSNs. Various ASN sharing architectures can include a NAP 305 that organizes multiple parallel business and service offering arrangements with different NSPs 310, 315 to provide multi-access for wireless subscribers of multiple NSPs 310, 315 that use the same ASN resource pools such as the ASNs provided by the NAP 305. FIG. 3 includes an example of ASN sharing via a WiMAX Network Reference Model (NRM). In some implementations, a single business concern such as a single wireless operator can own and manage both NAP 305 and NSP 310, 315 assets.

This document includes descriptions of technologies that enable a wireless device to dynamically discover a MCBCS controller's IP address or FQDN. Although it is possible to statically configure an IP address or a FQDN of the MCBCS controller in a wireless device, static configuration of the MCBCS controller's IP address or FQDN may be impractical in a roaming environment or an environment that shares the ASN with multiple service providers. In some implementations, a MCBCS service deployment can support both a static configuration and dynamic discovery of one or more MCBCS controllers for a wireless device.

Dynamic discovery of a MCBCS controller to support multicast broadcast services over a given wireless access network can include operation a wireless device to obtain an IP address such as an IPv4 or the IPv6 address of a MCBCS controller entity so that the wireless device can access or subscribe to the multicast or the broadcast programming from the controller. In a roaming environment or access serving network (ASN) sharing deployment, static configuration of the MCBCS controller's IP address may become difficult, therefore, a dynamic discovery technique can include one or more DHCP techniques to configure a MN with an IP address or a FQDN of a MCBCS controller in a wireless communication system.

FIG. 4 shows an example of a connectivity diagram between a wireless device and a multicast broadcast service controller. An anchor ASN 405 can host MCBCS related functions to control the MCBCS operation over a service area for one or more MCBCS broadcasts or multicast transmissions. A MN 410 can receive a downlink broadcast or a multicast transmission from a serving ASN 415. In some cases, an anchor ASN can be a serving ASN for a MN if the MN is receiving the downlink transmission from the anchor ASN.

Initial network entry procedures can include attaching a MN 410 to a ASN 415 to provide wireless service to the MN 410. A home NSP of the MN 410 can send a service profile associated with the MN 410 to the serving ASN 415 based on a successful authentication, e.g., user authentication, device authentication. A service profile can include access privilege information. For example, a service profile can include information to permit the MN 410 to leverage the a capability of a serving ASN 415 to access MCBCS provided by a network such as a NSP's CSN or by the business associated with a MCBCS Content Provider Network.

The home NSP can include a CSN 420. An AAA server 425 in the CSN 420 can authenticate a MN and can permit access to a MCBCS controller 430 and associated MCBCS content server 435. In some implementations, a home AAA (H-AAA) server can provide a MN service profile that includes access information of one or more MCBCS controllers. In some implementations, a visiting AAA (V-AAA) server can provide a MN service profile that includes access information of one or more MCBCS controllers.

In some implementations, if the MN 410 has an access privilege to a MCBCS provided by the NSP's CSN 420, an IP address or a FQDN of a corresponding MCBCS controller 430, or an IP address or a FQDN of a DHCP server 440 is included in a MN service profile. If an IP address or a FQDN of a MCBCS controller is provided to a serving ASN 415, the ASN 415 can operate a DHCP Proxy to store information such as an IP address or a FQDN prior to a MN's transmission of a DHCP message such as a DHCPDISCOVER or a DHCPINFORM in the case of DHCPv4, or SOLICIT or INFORMATION REQUEST in the case of DHCPv6 to acquire address information of a MCBCS controller 430.

In some implementations, a MN can request one or more option codes as specified in RFC 4280 from a DHCP server to discover servers such as a MCBCS server. A DHCP server can return one or more corresponding configuration options that carry information such as an IP address or a FQDN of a MCBCS controller to respond to the MN's request. In some implementations, a MN can discover one or more MCBCS controllers. In some implementations, a MN can support multiple MCBCS sessions over the same MN access or logon session with a serving ASN 415 and a CSN 420.

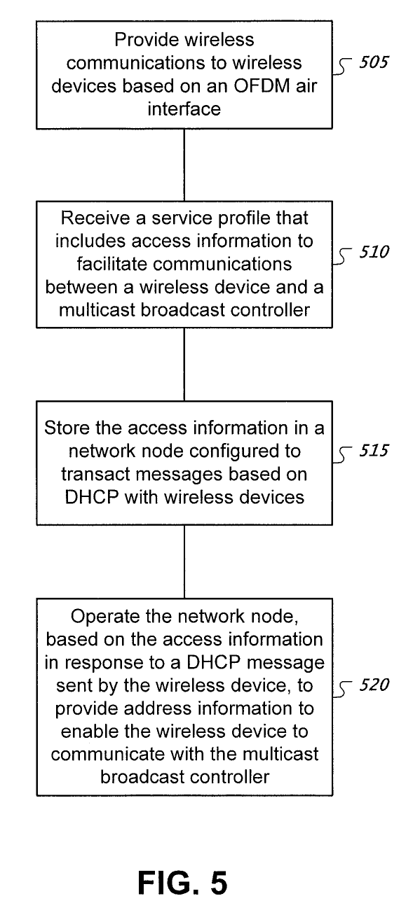

FIG. 5 shows an example of a dynamic discovery process in an ASN. An ASN can provide wireless communications to wireless devices based on an OFDM air interface (505). The ASN can receive a service profile that includes access information to facilitate communications between a wireless device and a multicast broadcast controller (510). In some implementations, the ASN can receive a service profile associated with a wireless device from a CSN which is configured to determine whether the wireless device has privilege to access a multicast broadcast controller. The ASN can store the access information in a network node, e.g., DHCP Proxy or Relay, configured to transact messages based on DHCP with wireless devices (515). The ASN can operate the network node, based on the access information in response to a DHCP message sent by the wireless device, to provide address information to enable the wireless device to communicate with the multicast broadcast controller (520).

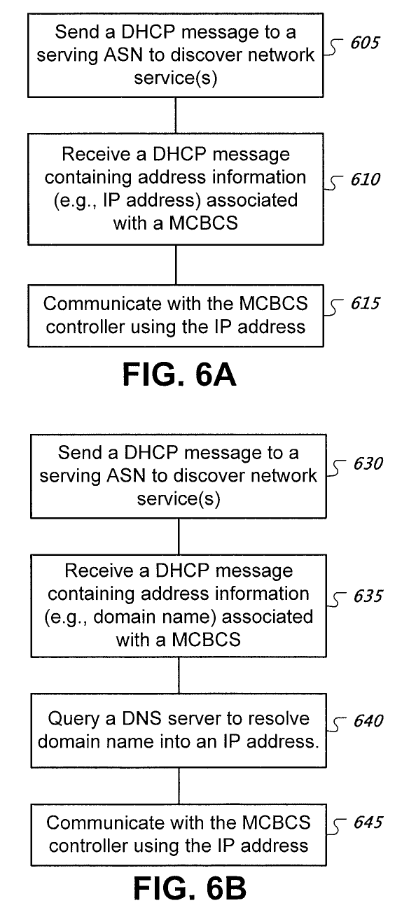

FIG. 6A shows an example of a dynamic discovery process in a wireless device. A wireless device can send a DHCP message to a serving ASN to discover network service(s) (605). The wireless device can receive a DHCP message containing address information (e.g., IP address) associated with a MCBCS (610). The wireless device can communicate with the MCBCS controller using the IP address (615).

FIG. 6B shows a different example of a dynamic discovery process in a wireless device. A wireless device can send a DHCP message to a serving ASN to discover network service(s) (630). The wireless device can receive a DHCP message containing address information (e.g., domain name) associated with a MCBCS (635). The wireless device can query a DNS server to resolve a received domain name into an IP address (640). The wireless device can communicate with the MCBCS controller using the IP address (645).

An ASN can communicate with a server such as an AAA server to authenticate a MN attempting to access the wireless services provided by the ASN. The AAA server can provide information to the ASN to enable a MN to access one or more MCBCS controllers if the MN has an associated access privilege. A MN can dynamically discover address information associated with one or more MCBCS controllers. Various examples of address information include a MCBCS controller IP address and a domain name such as a FQDN.

In some implementations, a MN can use DHCPv4 for discovery and can use DHCP messages such as the DHCPDISCOVER or DHCPINFORM messages to acquire address information associated with a MCBCS controller. In some implementations, address information can include one or more MCBCS controller domain names. A DHCPv4 server can include a Broadcast Service Controller Domain Name list option in a DHCPACK message to send domain name address information to a MN. In some implementations, address information can include one or more MCBCS controller IPv4 addresses. A DHCPv4 server can include a Broadcast Service Controller IPv4 address option in a DHCPACK message to send IP address information to a MN.

In some implementations, a MN can use DHCPv6 for discovery and can use DHCP messages such as the SOLICIT or INFORMATION-REQUEST message to acquire address information associated with a MCBCS controller. In some implementations, a MN can use an Option-Request-Option in a SOLICIT or INFORMATION-REQUEST message with the appropriate option-code set as specified in RFC 4280 to acquire address information. In some implementations, address information can include one or more MCBCS controller domain names. A DHCPv6 server can include a Broadcast Service Controller Domain Name list Option in a REPLY message to send domain name address information to a MN. In some implementations, address information can include one or more MCBCS controller IPv6 addresses.

In some implementations, a MN can acquire domain names according to RFC 4280. A MN can query a DNS to resolve a domain name into an IP address. In some implementations, a MN can use a DNS query that includes a service (SRV) record format such as “_bcmcs._tcp.domain” to obtain an IP address such as an IPv4 or IPv6 address of the MCBCS controller pertaining to a domain name in the DNS query.

A MN can obtain one or more IP addresses of one or more MCBCS controllers to perform MCBCS information acquisition. The MN can acquire MCBCS programming information from the MCBCS controller using the one or more IP addresses. MCBCS programming information can include one or more of an IP multicast address of MCBCS programming, program description, and a programming schedule time.

Various ASNs can include one or more network nodes such as a DHCP Proxy or DHCP Relay. In the case where the ASN receives the IP address(es) or FQDN(s) of the MCBCS Controller(s) from an AAA server after a successful MN access authentication with the ASN, a DHCP Proxy function can be used at the ASN to support the dynamic discovery of the MCBCS controller. If the ASN receives the IP address or FQDN of the DHCP server from the AAA server, a DHCP Relay function can be used at the ASN to support the dynamic discovery of the MCBCS controller.

Upon receiving the DHCPDISCOVER or DHCPINFORM message from the MN, if the DHCP Proxy or DHCP server is configured with the MCBCS controller information, the DHCP Proxy or the DHCP server can include the BCMCS Controller IPv4 address and/or BCMCS Controller domain name(s). The DHCP Proxy and DHCP Server can support the BCMCS controller inquiry options as specified in RFC 4280. If the information has been configured, the DHCP Proxy or DHCP Server can respond with the DHCPACK to the MN with the corresponding MCBCS controller information.

Upon receiving the SOLICIT or INFORMATION-REQUEST message from the MN using the Option-Request-Option with the option code set for requesting MCBCS controller's IPv6 address/domain name as specified in RFC 4280, the DHCPv6 server includes Broadcast Service Controller Domain Name list Option and/or Broadcast Service Controller IPv6 address option in the REPLY message to send MCBCS controller's IP address(es) and/or domain name(s) to the MN as specified in RFC 4280.

Various ASNs can include a DHCP relay node that is configured to communicate with one or more DHCP servers. In some implementations, a DHCP relay node can communicate with a DHCP server in a home CSN associated with a MN. In some implementations, a home AAA server can return an IP address of a DHCP server in lieu of address information of a MCBCS controller. A DHCP server associated with the MN can provide address information such as an IP address or FQDN of a MCBCS controller. For example, after attaching to the ASN, a MN can send a DHCP message to a node such as a DHCP relay node which can contact the DHCP for the MCBCS controller information. In some implementations, a MN can leverage the DHCP MCBCS IP configuration information in a home network to proceed with a MCBCS information acquisition procedure.

In some implementations, wireless communication systems can support static provisioning of MCBCS information and dynamic discovery of MCBCS information over the same ASN with direct or in-direct connectivity with multiple CSNs. Service provisioning policy can be on a per-MN basis. A MN can obtain a MCBCS controller IP address(es) via a technique such as static provisioning or dynamic discovery techniques. In some implementations, a MN can use the same MCBCS information acquisition technique regardless of which technique the MN uses to obtain a MCBCS controller IP address.

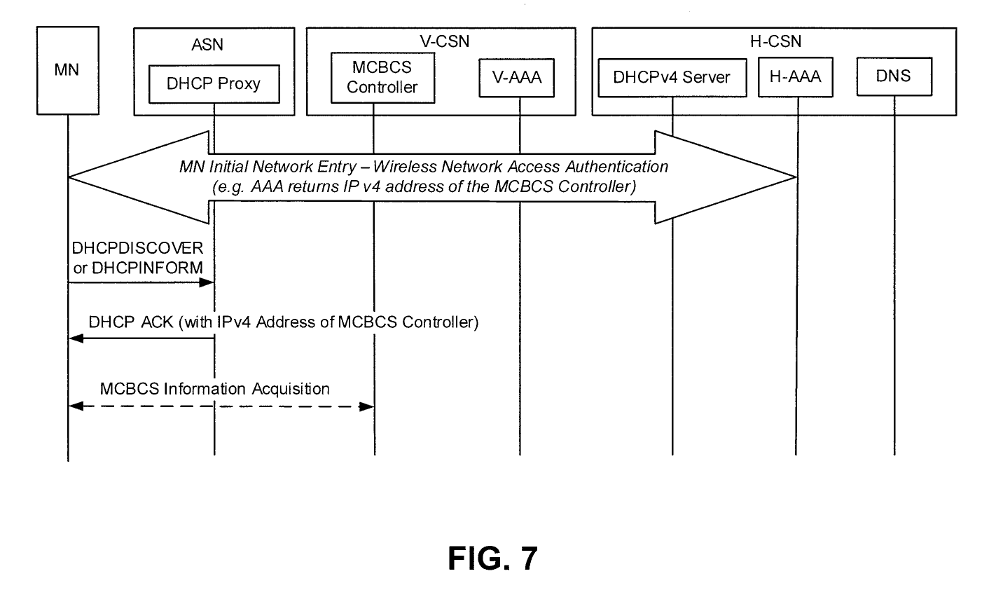

FIGS. 7-14 show various examples of communications flows associated with different dynamic discovery techniques. Dynamic discovery techniques can be applied to one or more MCBCS controllers. A MN can discover one or more MCBCS controllers, which can have different services such as different broadcast and multicast service sessions), therefore, one or more IP addresses or FQDNs of the MCBCS controllers can be provided to the MN during a discovery process.

FIG. 7 shows an example of a dynamic discovery of a MCBCS Controller using DHCPv4. In this example, a MN can obtain an IPv4 address associated with a MCBCS Controller. During a network entry procedure, an AAA server in a CSN can send an IPv4 address of a MCBCS controller to a server in the serving ASN. The server can store the IPv4 of the MCBCS controller address in a DHCP Proxy of the serving ASN. In some implementations, the DHCP proxy can store MCBCS controller address information and identities of MNs that are permitted to have access to the MCBCS. The MN can send a DHCPv4 message such as a DHCPDISCOVER or DHCPINFORM message towards an ASN. A DHCP Proxy can respond to the MN with an IPv4 address of the MCBCS controller in a message such as a DHCPACK message.

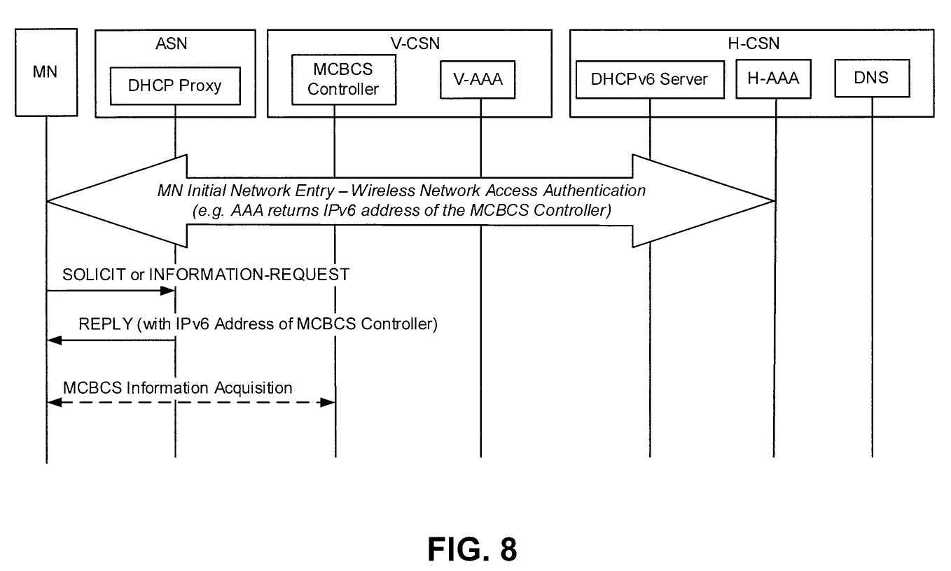

FIG. 8 shows an example of a dynamic discovery of a MCBCS Controller using DHCPv6. In this example, a MN can obtain an IPv6 address associated with a MCBCS Controller. During a network entry procedure, an AAA server in a CSN can send one or more IPv6 addresses of a MCBCS controller to a server in the serving ASN. The server can store the IPv6 of the MCBCS controller address in a DHCP Proxy of the serving ASN. The MN can send a DHCPv6 message such as a SOLICIT or INFORMATION-REQUEST message towards an ASN. A DHCP Proxy can respond to the MN with an IPv6 address of the MCBCS controller in a message such as a REPLY message.

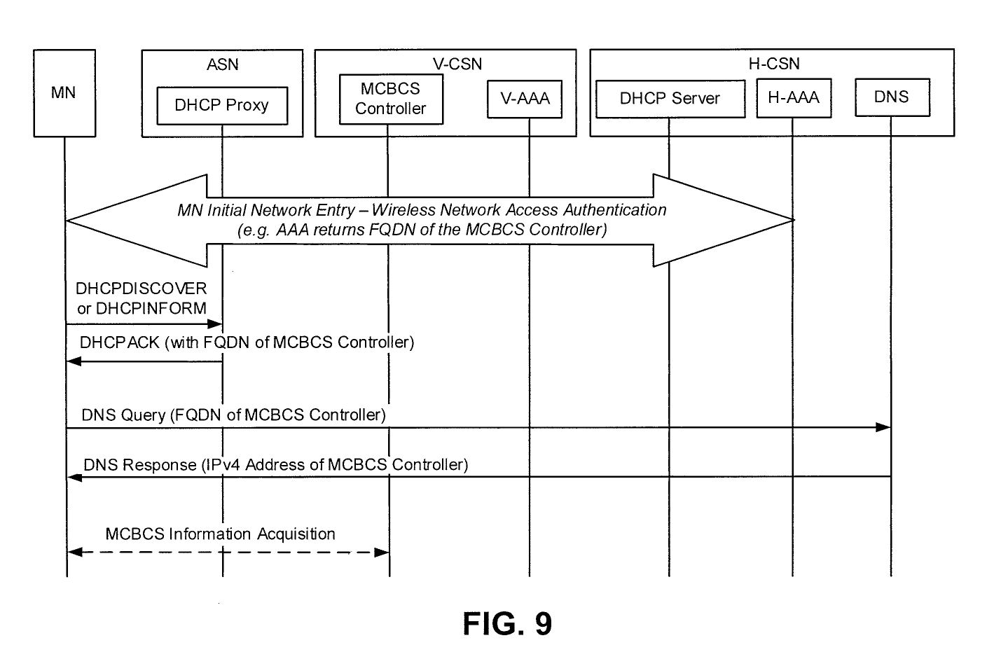

FIG. 9 shows an example of a dynamic discovery of a MCBCS Controller using DHCPv4 and DNS. In this example, a MN can obtain a FQDN associated with a MCBCS Controller. During a network entry procedure, an AAA server in a CSN can return one or more FQDNs of a MCBCS controller to the serving ASN. The serving ASN can store the FQDN at a DHCP Proxy in the serving ASN. The MN can send a DHCPv4 message such as a DHCPDISCOVER or DHCPINFORM message towards an ASN. The DHCP Proxy can respond to the MN with one or more FQDNs of the MCBCS controller in the DHCPACK message. A MN can obtain query a DNS server with the one or more FQDNs to obtain an IPv4 address associated with the MCBCS Controller. The DNS server can respond to the MN with a DNS response that includes an IPv4 address of the MCBCS controller.

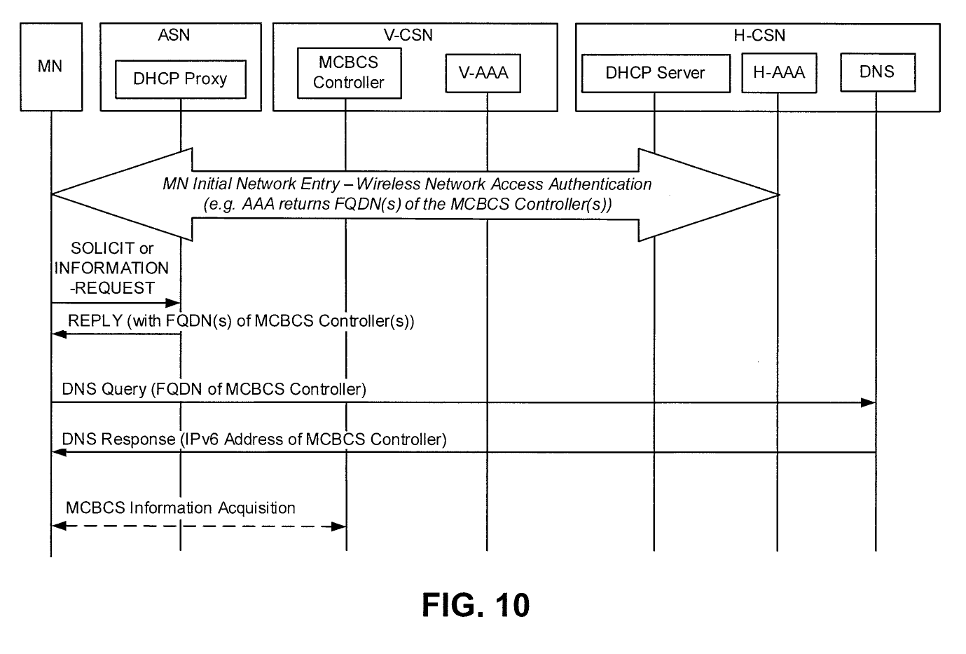

FIG. 10 shows an example of a dynamic discovery of a MCBCS Controller using DHCPv6 and DNS. In this example, a MN can obtain a FQDN associated with a MCBCS Controller. During a network entry procedure, an AAA server can return one or more FQDNs of a MCBCS controller to a serving ASN. The serving ASN can store the returned FQDN(s) at a DHCP Proxy of the serving ASN. The MN can send a DHCPv6 message such as a SOLICIT or INFORMATION-REQUEST message towards to the serving ASN. The DHCP Proxy can respond to the MN with a FQDN of the MCBCS controller in the REPLY message. The MN can perform a DNS query that includes the FQDN towards a DNS server to obtain an IPv6 address of the MCBCS controller. The DNS server can respond to the MN with a DNS response including an IPv6 address of the MCBCS controller.

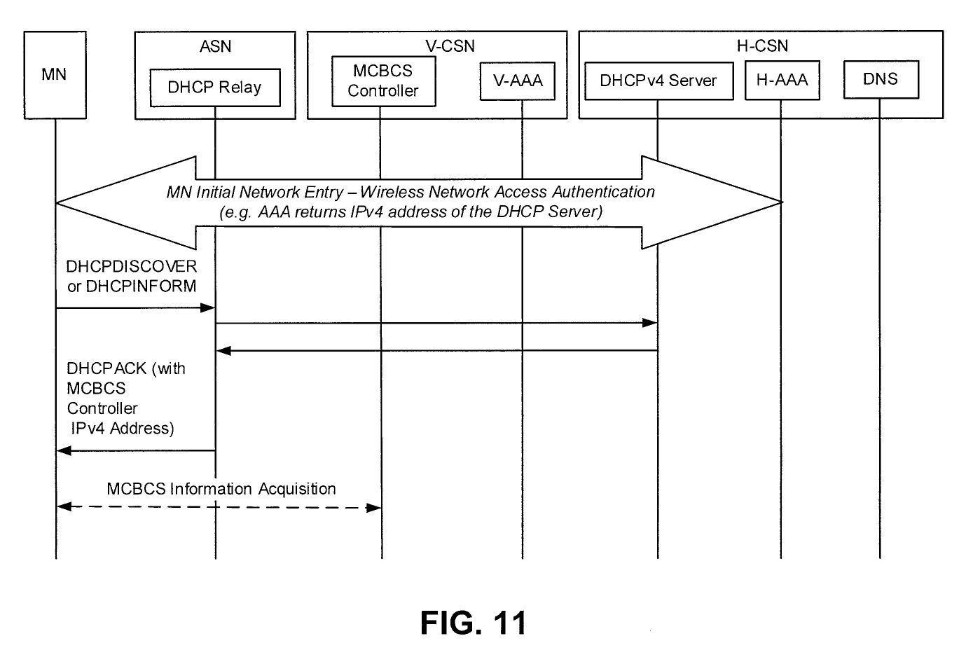

FIG. 11 shows an example of a dynamic discovery of a MCBCS Controller via a DHCP Relay using DHCPv4. During a network entry procedure, an AAA server in a CSN can return an IPv4 address of a DHCPv4 server that has an IPv4 address of a MCBCS controller associated with the MN that is entering the ASN. The ASN can store the IPv4 address of the DHCPv4 server in a DHCP Relay of the serving ASN. In some implementations, the ASN can associate the DHCPv4 server address information with an identity of the MN to control access to the address information. The MN can send a DHCPv4 message such as a DHCPDISCOVER or DHCPINFORM message towards the serving ASN. The DHCP Relay can forward a message such as a DHCPDISCOVER or DHCPINFORM message to a DHCPv4 server of a home CSN associated with the requesting MN. The DHCPv4 server can respond to the DHCP Relay with the DHCPACK which can include an IPv4 address of the MCBCS controller. The DHCP Relay can forward the DHCPACK towards the MN.

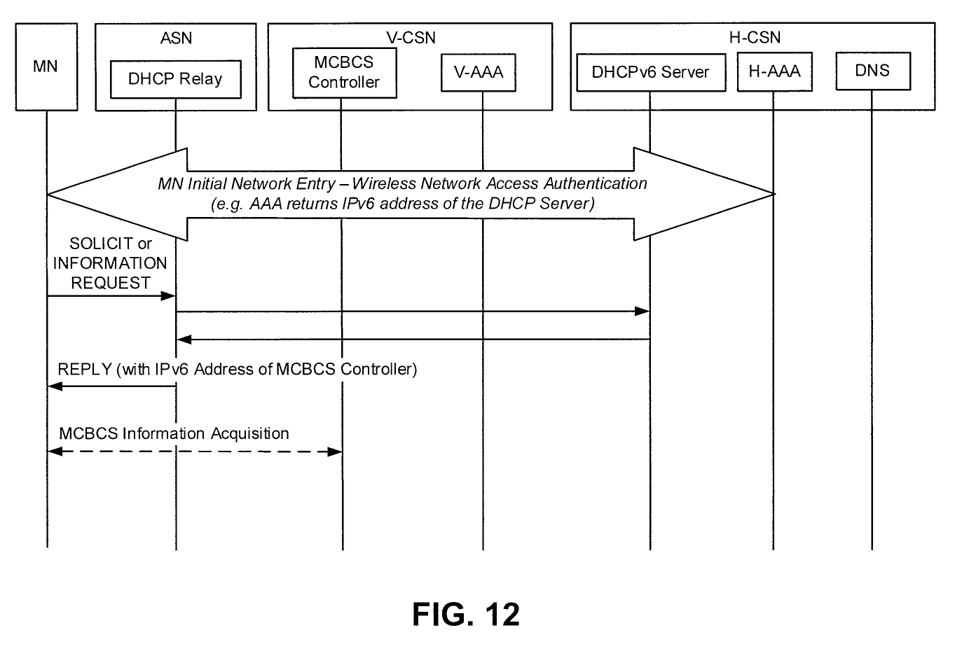

FIG. 12 shows an example of a dynamic discovery of a MCBCS Controller via a DHCP Relay using DHCPv6. During a network entry procedure, an AAA server can return an IPv6 address of a DHCPv6 server that has an IPv6 address of a MCBCS controller to an ASN in communication with a MN. The serving ASN can store an IPv6 address of the DHCPv6 server in a DHCP Relay of the serving ASN. The MN can send a DHCPv6 message such as a SOLICIT or INFORMATION-REQUEST message towards the serving ASN. The DHCP Relay can forward the SOLICIT or INFORMATION-REQUEST message to the DHCPv6 server. The DHCPv6 server can respond to the DHCP Relay with a REPLY message which can include the IPv6 address of the MCBCS controller. The DHCP Relay can forwards the REPLY towards the MN.

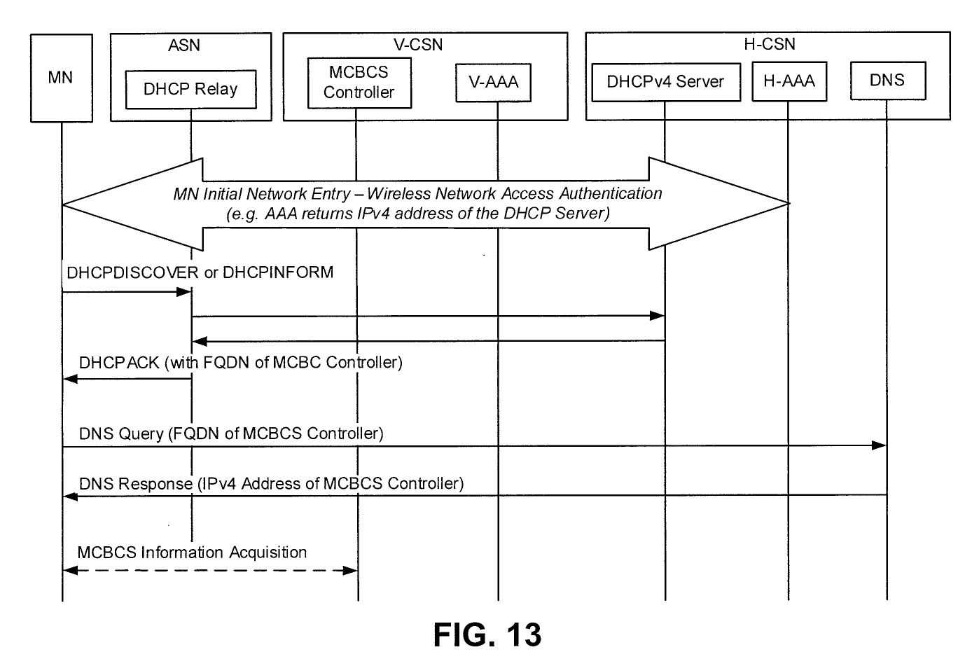

FIG. 13 shows an example of a dynamic discovery of a MCBCS Controller associated via a DHCP Relay using DHCPv4 and DNS. During a network entry procedure, an AAA server in a CSN can return an IPv4 address of a DHCPv4 server that has a FQDN of a MCBCS controller associated with an MN to a serving ASN. The serving ASN can store the IPv4 address of the DHCPv4 server in a DHCP Relay of the serving ASN. The MN can send a DHCPv4message such as a DHCPDISCOVER or DHCPINFORM message towards the ASN. The DHCP Relay can forward a message such as a DHCPDISCOVER or DHCPINFORM message to the DHCPv4 server. The DHCPv4 server can respond to the DHCP Relay with the DHCPACK which includes the FQDN of the MCBCS controller. The MN can send a DNS Query to DNS server to obtain the corresponding IPv4 address of the MCBCS controller. The DNS server can respond to the MN with an IPv4 address of the MCBCS controller.

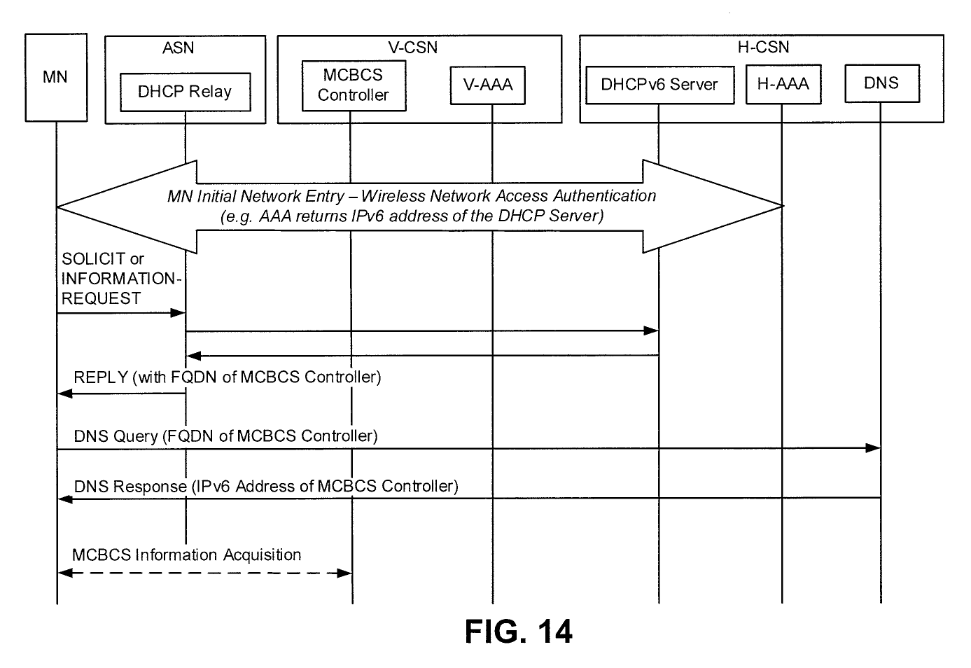

FIG. 14 shows an example of a dynamic discovery of a MCBCS Controller via a DHCP Relay using DHCPv6 and DNS. During a network entry procedure, an AAA server can return the IPv6 address of a DHCPv6 server associated with the MN in the entry procedure. The returned DHCPv6 server can store one or more FQDNs of the MCBCS controller associated with the MN to the serving ASN. The serving ASN can store the IPv6 address of the DHCPv6 server in a DHCP Relay of the serving ASN. The MN can send a DHCPv6 message such as a SOLICIT or INFORMATION-REQUEST message towards the ASN. The DHCP Relay can forward a message such as a SOLICIT or INFORMATION-REQUEST message to the DHCPv6 server. The DHCPv6 server can respond to the DHCP Relay with a REPLY message which includes the FQDN of the MCBCS controller. The DHCP relay can forward the REPLY message to the MN. The MN can send a DNS query which includes the FQDN to a DNS server to obtain the corresponding IPv6 address of the MCBCS controller. The DNS server can respond to the MN with an IPv6 address of the MCBCS controller.

In some implementations, DHCHv4 and DHCPv6 server capabilities can include support for dynamic discovery of one or more multicast broadcast controllers in a wireless communications systems such as one based on WiMAX or LTE. Wireless communications systems can include for support static and dynamic techniques for determining address information of a multicast broadcast controller. A pre-provisioning technique can include a static configuration of information such as the IP address(es) and FQDN(s) for the MCBCS controller(s) in a memory of a MN. Dynamic techniques can include a dynamic discovery of information such as the IP address(es) and FQDN(s) of the MCBCS controller(s) in multiple CSNs. In some implementations, entities such as a MN and an ASN can obtain dynamically assigned MCBCS controller information based on addressing information (e.g., IP address or FQDN of the MCBCS controller) or based on retrieving MCBCS controller configuration information from a DHCP server dynamically once the MS is successful authenticated by the ASN to access the wireless access network resources. One or more MCBCS controllers can be supported by features described in this document to provide one or more MCBCS sessions from one or more content providers to a MN over the same duration of the MN access session with the ASN and with the CSN.

The disclosed and other embodiments and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communications, comprising:
operating an access service network to provide wireless communications to wireless devices based on an orthogonal frequency-division multiplexing air interface;
receiving a service profile associated with a wireless device from a connectivity service network which is configured to determine whether the wireless device has privilege to access a multicast broadcast controller, the service profile comprising access information to facilitate communications between the wireless device and the multicast broadcast controller;
storing the access information in a network node configured to transact messages based on a Dynamic Host Configuration Protocol (DHCP) with wireless devices; and
operating the network node, based on the access information in response to a DHCP message sent by the wireless device, to provide address information to enable the wireless device to communicate with the multicast broadcast controller.

2. The method as in claim 1, wherein operating the network node comprises sending an Internet Protocol (IP) address associated with the multicast broadcast controller to the wireless device, wherein the access information includes the IP address.

3. The method as in claim 1, wherein operating the network node comprises sending a fully qualified domain name (FQDN) associated with the multicast broadcast controller to the wireless device, wherein the access information includes the FQDN.

4. The method as in claim 3, further comprising:
causing the wireless device to perform a Domain Name System (DNS) lookup on the FQDN to obtain an Internet Protocol (IP) address associated with the multicast broadcast controller.

5. The method as in claim 1, wherein the access information includes an Internet Protocol (IP) address associated with a DHCP server which stores information pertaining to the multicast broadcast controller.

6. The method as in claim 5, wherein operating the network node comprises communicating with the DHCP server to obtain an IP address associated with the multicast broadcast controller, wherein the address information includes the IP address associated with the multicast broadcast controller.

7. The method as in claim 5, wherein operating the network node comprises communicating with the DHCP server to obtain a fully qualified domain name (FQDN) associated with the multicast broadcast controller, wherein the address information includes the FQDN.

8. The method as in claim 7, further comprising:
causing the wireless device to perform a Domain Name System (DNS) lookup on the FQDN to obtain an Internet Protocol (IP) address associated with the multicast broadcast controller.

9. The method as in claim 1, wherein operating the network node comprises transacting DHCP messages with the wireless device, wherein the DHCP includes a DHCP for Internet Protocol (IP) version 6.

10. The method as in claim 1, wherein operating the network node comprises transacting DHCP messages with the wireless device, wherein the DHCP includes a DHCP for Internet Protocol (IP) version 4.

11. An access service network, comprising:
means for providing wireless communications to wireless devices based on an orthogonal frequency-division multiplexing air interface;
means for receiving a service profile associated with a wireless device from a connectivity service network which is configured to determine whether the wireless device has privilege to access a multicast broadcast controller, the service profile comprising access information to facilitate communications between the wireless device and the multicast broadcast controller;
a transaction mechanism that transacts messages based on a Dynamic Host Configuration Protocol (DHCP) with wireless devices; and
means for storing the access information in the transaction mechanism to operate the transaction mechanism, based on the access information in response to a DHCP message sent by the wireless device, to provide address information to enable the wireless device to communicate with the multicast broadcast controller.

12. The network as in claim 11, wherein the transaction mechanism comprises means for sending an Internet Protocol (IP) address associated with the multicast broadcast controller to the wireless device, wherein the access information includes the IP address.

13. The network as in claim 11, wherein the transaction mechanism comprises means for sending a fully qualified domain name (FQDN) associated with the multicast broadcast controller to the wireless device, wherein the access information includes the FQDN.

14. The network as in claim 13, further comprising:
means for causing the wireless device to perform a Domain Name System (DNS) lookup on the FQDN to obtain an Internet Protocol (IP) address associated with the multicast broadcast controller.

15. The network as in claim 11, wherein the access information includes an Internet Protocol (IP) address associated with a DHCP server which stores information pertaining to the multicast broadcast controller.

16. The network as in claim 15, wherein the transaction mechanism comprises means for communicating with the DHCP server to obtain an IP address associated with the multicast broadcast controller, wherein the address information includes the IP address associated with the multicast broadcast controller.

17. The network as in claim 15, wherein the transaction mechanism comprises means for communicating with the DHCP server to obtain a fully qualified domain name (FQDN) associated with the multicast broadcast controller, wherein the address information includes the FQDN.

18. The network as in claim 17, further comprising:
means for causing the wireless device to perform a Domain Name System (DNS) lookup on the FQDN to obtain an Internet Protocol (IP) address associated with the multicast broadcast controller.

19. The network as in claim 11, wherein the transaction mechanism comprises means for transacting DHCP messages with the wireless device, wherein the DHCP includes a DHCP for Internet Protocol (IP) version 6.

20. The network as in claim 11, wherein the transaction mechanism comprises means for transacting DHCP messages with the wireless device, wherein the DHCP includes a DHCP for Internet Protocol (IP) version 4.

21. A wireless communication system, comprising:
a multicast broadcast controller configured to control multicast and broadcast services;
a connectivity service network which is configured to determine whether wireless devices have a privilege to access the multicast broadcast controller; and
an access service network, in communication with the connectivity service network and the multicast broadcast controller, comprising:
a base station configured to provide wireless communications to wireless devices based on an orthogonal frequency-division multiplexing air interface;
a network node configured to transact messages based on a Dynamic Host Configuration Protocol (DHCP) with wireless devices,
a mechanism configured to receive a service profile associated with a wireless device from the connectivity service network, the service profile comprising access information to facilitate communications between the wireless device and the multicast broadcast controller, and to store the access information in the network node,
wherein the network node is configured to provide, based on the access information in response to a DHCP message sent by the wireless device, address information to enable the wireless device to communicate with the multicast broadcast controller.

22. The system as in claim 21, wherein the network node is configured to send an Internet Protocol (IP) address associated with the multicast broadcast controller to the wireless device, wherein the access information includes the IP address.

23. The system as in claim 21, wherein the network node is configured to send a fully qualified domain name (FQDN) associated with the multicast broadcast controller to the wireless device, wherein the access information includes the FQDN.

24. The system as in claim 21, wherein the access information includes an Internet Protocol (IP) address associated with a DHCP server which stores information pertaining to the multicast broadcast controller.

25. The system as in claim 24, wherein the network node is configured to communicate with the DHCP server to obtain an IP address associated with the multicast broadcast controller, wherein the address information includes the IP address associated with the multicast broadcast controller.

26. The system as in claim 24, wherein the network node is configured to communicate with the DHCP server to obtain a fully qualified domain name (FQDN) associated with the multicast broadcast controller, wherein the address information includes the FQDN.

27. The system as in claim 21, wherein the network node is configured to transact DHCP messages with the wireless device, wherein the DHCP includes a DHCP for Internet Protocol (IP) version 6.

28. The system as in claim 11, wherein the network node is configured to transact DHCP messages with the wireless device, wherein the DHCP includes a DHCP for Internet Protocol (IP) version 4.

29. The system as in claim 21, wherein the wireless device comprises transceiver electronics to communicate with one or more access service networks based on an orthogonal frequency-division multiplexing air interface; and processor electronics, in communication with the transceiver electronics, configured to discover address information associated with the multicast broadcast controller.

30. The system as in claim 21, wherein the wireless device comprises:
a memory configured with pre-provisioned address information of a multicast broadcast controller; and
a mechanism to select between discovering address information of a multicast broadcast controller or using the pre-provisioned address information.
